(19) United States
(12) Patent Application Publication
(10) Pub. No.: US 2013/0311242 A1
(43) Pub. Date: Nov. 21, 2013

(54) Business Process Analytics

(71) Applicants: Matthew J. Duftler, Yorktown Heights, NY (US); Paul T. Keyser, Yorktown Heights, NY (US); Rania Khalaf, Cambridge, MA (US); Geetika T. Lakshmanan, Cambridge, MA (US); Mike A. Marin, Costa Mesa, CA (US); Nirmal K. Mukhi, Yorktown Heights, NY (US); Szabolcs Rozsnyai, Hawthorne, NY (US)

(72) Inventors: Matthew J. Duftler, Yorktown Heights, NY (US); Paul T. Keyser, Yorktown Heights, NY (US); Rania Khalaf, Cambridge, MA (US); Geetika T. Lakshmanan, Cambridge, MA (US); Mike A. Marin, Costa Mesa, CA (US); Nirmal K. Mukhi, Yorktown Heights, NY (US); Szabolcs Rozsnyai, Hawthorne, NY (US)

(73) Assignee: International Business Machines Corporation, Armonk, NY (US)

(21) Appl. No.: 13/476,739

(22) Filed: May 21, 2012

(51) Int. Cl. G06Q 10/06

(52) U.S. Cl. 705/7.36

(57) ABSTRACT

A system for visualizing a process includes a trace manager receiving a plurality of trace sets, each trace set having a plurality of business process execution traces, each of the business process execution traces being a representation of an individual work flow, a model generator creating a model from each of the trace sets, each model being a directed graph including a work flow of an aggregate of the business process execution traces in a respective trace set, a model comparator extracting a plurality of differences between the models and creating a comparison result based on the plurality of differences, wherein the comparison result is stored to a collaborative system, and a trace set identifier configured to identify a subset of the trace set based on a selected subsection of the model, where the subset of trace set exhibits at least one difference extracted from the selected subsection of the model.

### BACKGROUND OF THE INVENTION

1. Technical Field

The present disclosure generally relates to analytics, and more particularly to analytics for business process management.

2. Discussion of Related Art

Case management challenges require insight, responsiveness, and collaboration. Case management strategy unifies information, processes, and people to provide a complete view of the case. Case management provides analytics, business rules, collaboration, and social software to create more successful case outcomes.

### BRIEF SUMMARY

According to an embodiment of the present disclosure, a data exploration tool includes a trace manager receiving a plurality of trace sets, each trace set having a plurality of business process execution traces, each of the business process execution traces being a representation of an individual work flow, a model generator creating a model from each of the trace sets, each model being a directed graph including a work flow of an aggregate of the business process execution traces in a respective trace set, a model comparator extracting a plurality of differences between the models and creating a comparison result based on the plurality of differences, wherein the comparison result is stored to a collaborative system, and a trace set identifier configured to identify a subset of the trace set based on a selected subsection of the model, where the subset of trace set exhibits at least one difference extracted from the selected subsection of the model.

According to an embodiment of the present disclosure, a method of identifying differences between business process execution traces includes receiving a plurality of trace sets, each trace set having a plurality of business process execution traces, each of the business process execution traces being a representation of an individual work flow, creating a model from each of the trace sets, each model being a directed graph including a work flow of an aggregate of the business process execution traces in a respective trace set, extracting a plurality of differences between the models and creating a comparison result based on the plurality of differences, and identifying a subset of the trace set based on a selected subsection of the model, where the subset of trace set exhibits at least one difference extracted from the selected subsection of the model.

According to an embodiment of the present disclosure, a method of identifying differences between business process execution traces includes receiving a plurality of trace sets, each trace set having a plurality of business process execution traces, each of the business process execution traces being a representation of an individual work flow, creating a model from each of the trace sets, each model being a directed graph including a work flow of an aggregate of the business process execution traces in a respective trace set, extracting a plurality of differences between the models and creating a comparison result based on the plurality of differences, identifying a subset of the trace set based on a selected subsection of the model, where the subset of trace set exhibits at least one difference extracted from the selected subsection of the model, and displaying the subset of the trace set as an overlay on the selected subsection of the model, wherein the overlay is determined as based on intersections between the subset of the trace set and the selected subsection of the model

### BRIEF DESCRIPTION OF THE SEVERAL VIEWS OF THE DRAWINGS

Preferred embodiments of the present disclosure will be described below in more detail, with reference to the accompanying drawings:

FIG. 1 is an exemplary case model including tasks according to an embodiment of the present disclosure;

FIG. 2 is an exemplary process model of a task, the process model including activities (A, B, C, D, E, F, G, H) according to an embodiment of the present disclosure;

FIG. 3A is a probabilistic graph model (PGM) of an automobile insurance process according to an exemplary embodiment of the present disclosure;

FIG. 3B is an annotated probabilistic graph model of FIG. 3A showing a most probable path according to an exemplary embodiment of the present disclosure;

FIG. 4 is an exemplary interface showing a case model, according to an exemplary embodiment of the present disclosure;

FIG. 5A is a flow diagram of a method for creating an overlay of a process instance on a model, according to exemplary embodiments of the present disclosure;

FIGS. 5B-C are exemplary displays of a trace visualizer, according to exemplary embodiments of the present disclosure;

FIG. 6 is a flow diagram of a method for automated data exploration according to an embodiment of the present disclosure;

FIG. 7 is a diagram of a data exploration tool according to an embodiment of the present disclosure; and

FIG. 8 is a diagram of a computer system for implementing a method for applying analytics for case management according to an embodiment of the present disclosure.

### DETAILED DESCRIPTION

According to an embodiment of the present disclosure, data related to a case or business process may be aggregated from different case instances to generate a model, which may be visualized and analyzed. The model may be dynamically updated with mined information. Further, an interface of the model may be customized.

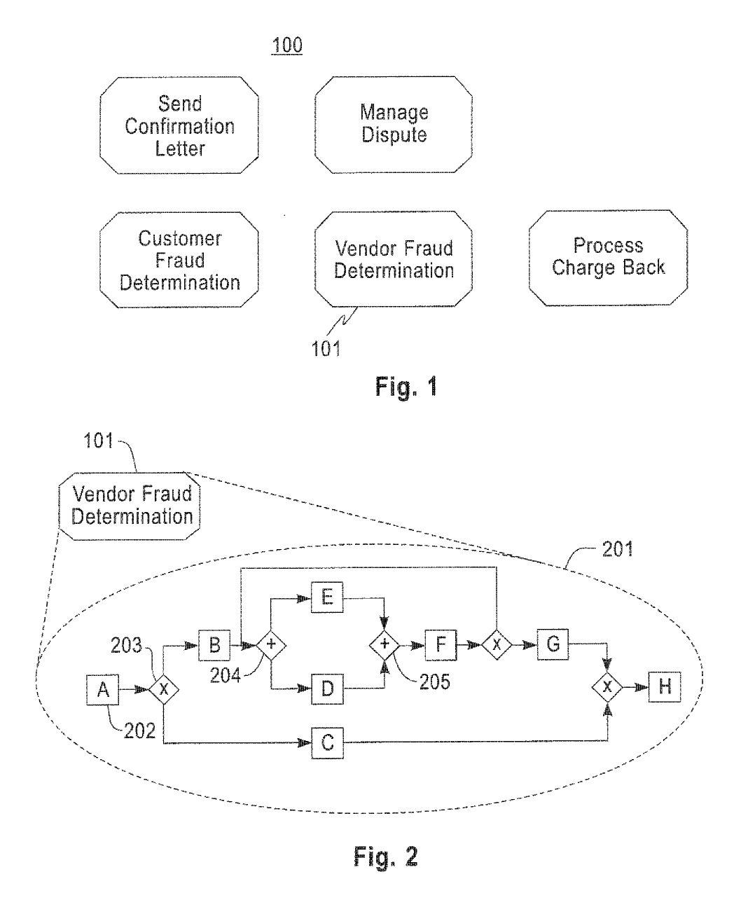

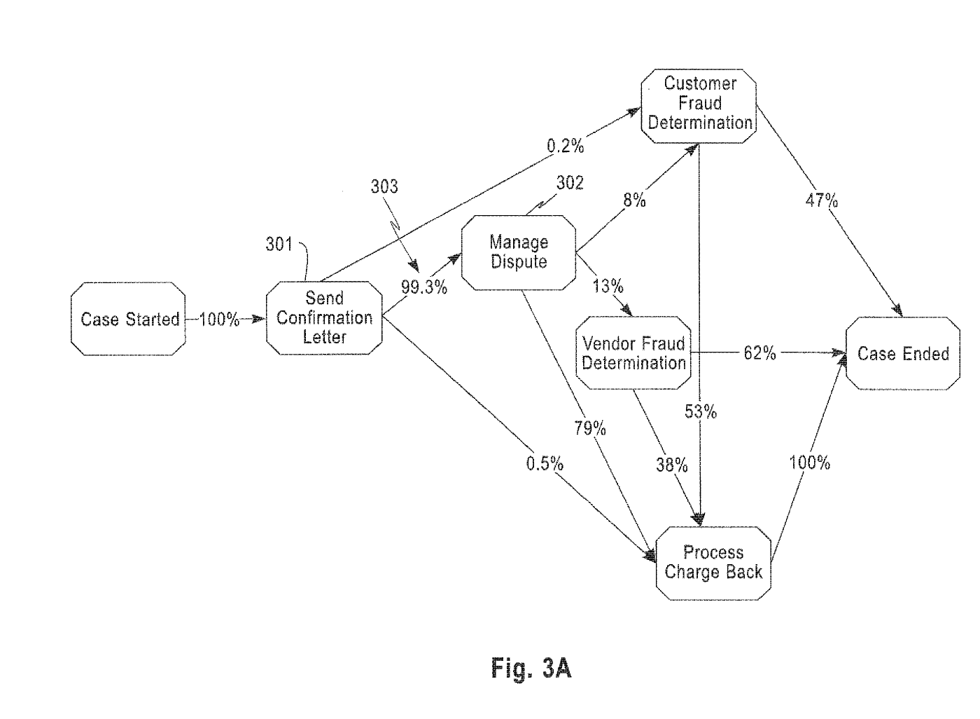

Methods described herein are applicable for cases and to business processes, including structured business processes (e.g., wherein all flows in the process are known and guaranteed) and unstructured business processes. Referring to FIGS. 1 and 2, a case or business process 100 contains tasks, e.g., 101. Each task may be implemented by a process 201, which may include activities, e.g., 202.

Further, a case model is defined by a set of tasks, while a business process instance includes a sequence of tasks. Each task may have data associated with it. For example, in an automobile insurance case, a task may be associated with a business process' incoming document related data, such as a claim document. Each instance of the business process may also be associated with data. Events may be captured and stored for each task during an execution of a business process to generate an execution trace. By mining execution traces of the business process, a model of the business process may be created. Exemplary models include a probabilistic graph model (PGM), a business process model (PM), a probabilistic process model (PPM), etc.

According to an embodiment of the present disclosure, a user may select a set of execution traces from which models may be mined. An execution trace corresponds to a single case instance or process instance and consists of a recorded history of tasks, data and events that occurred in an the instance. A one or more analytic methods (hereinafter analytics) may be applied to the mined models. Exemplary analytics include methods for comparing behavior of different case workers, viewing a most common sequence of steps, analyzing anomalous behavior of case workers in handing a particular kind of case, and viewing the most common tasks executed. While each example is described in more detail herein, it should be understood the present disclosure is not limited to the exemplary analytic methods described herein.

In the case of comparing the behavior of different case workers in handling cases, a subset of traces may be selected that show how case worker “A” handles cases. A second subset of traces may be selected that show how case worker “B” handles cases. After mining models from each trace set, the models may be visually compared and distances between the mined models may be determined using techniques such as process model similarity metrics. The distance between two models, A and B, could be defined as the number of “add” and “delete” (applied to nodes or edges) operations applied to model A in order to convert it to model B.

In the case of viewing a most common sequence of tasks, consider the example of viewing tasks taken to handle cases from a particular geography. In this case, a most probable path through a mined probabilistic graph model of a set of execution traces for a certain geography can be visualized. Further, a most common path for case workers in one location may be compared to another location.

To analyze anomalous behavior of case workers in handing a particular kind of case, a subset of execution traces that exhibit the anomaly may be examined. This can be accomplished by viewing a mined model of the business process, selecting a sub graph of the mined model that contains a set or sequence of tasks that have connections that are determined to be anomalous. A set of execution traces corresponding to the set of tasks can be identified and viewed in a tool that allows visualization of individual traces. Various methods for detecting anomalous connections may be implemented. For example, a control point may be a condition specified by the user that must be satisfied. In another example, a control point may specify that an amount must be greater than $100 for task “special packaging” to execute. A system can track when control points, e.g., the task(s) and/or connections executing, are violated. Thus, control point violation may highlight anomalous connections in the mined model. Another method of detecting anomalous behavior is to mine a probabilistic graph model (PGM) of case handling behavior from a set of completed case instances. Connections with lowest probability in the PGM may serve as a potential set of anomalous connections. In yet another example, anomalous connections may be detected through a user's input. The user can annotate a mined model with notes identifying connections as anomalous.

According to an embodiment of the present disclosure, a model may be dynamically updated with mined information. These updates may be to the views of a case management system in response to statistics and analytical data derived from the mined model. For example, as new execution traces of one or more instances of a case model are considered, the mined model may be updated along with a corresponding view.

In one example of a dynamic update, a user may highlight an individual task in a case model by selecting links on the task to view detailed statistics about the task and view individual execution traces that exhibit a specific behavior captured by the statistics.

In another example of a dynamic update, one or more aspects of a mined graphical model may be highlighted and displayed, where the aspects are derived from execution traces of one or more case model instances. In this example, a user may identify a subset of mined graphical models and view execution traces that exhibit a behavior captured by the subset of the mined models, and using a trace visualizer to view the properties of each individual trace.

In another example of a dynamic update, two or more mined models may be compared. The mined models may be determined from execution traces of instances belonging to at least one case model and providing the user with numeric measures of the similarity or differences between the mined models. Model comparison may be used to compare the way two different case workers handle a case. More particularly, a model of how case worker 1 handles 100 cases may be determined by mining a model (Model1) from one hundred execution traces of cases handled by case worker 1. The same can be done for case worker 2 to create Model2. Then a model comparison method may be implemented, or a model comparison method may be implemented where the most common path found in Model1 is compared with the most common path found in Model2.

In still another example of a dynamic update, information related to a next step on each task in a case model may be provided. This information may be provided on the basis of statistical calculations derived about the task from a mined model of the case determined from case model execution instances.

In yet another example of a dynamic update, user customizable views of mined models of the case model from execution traces of case instances may be generated, allowing a user to customize these views to highlight information about a case that is pertinent to its execution.

The updates may be across case models, and across time periods within which the set of execution instances belonging to a case model is updated.

The updates may allow a user interacting with a case to prioritize different updates and display select combinations of the updates, where some items may be hidden while others are displayed each time a person interacting with a case opens the case management system.

According to an embodiment of the present disclosure, users may browse a list of historical traces and view an individual trace in the list using a trace visualizer. The trace visualizer may be, for example, a table of tasks with associated data and actors. The individual trace or a subset of traces may be selected from the list.

Referring now to the figures; the flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

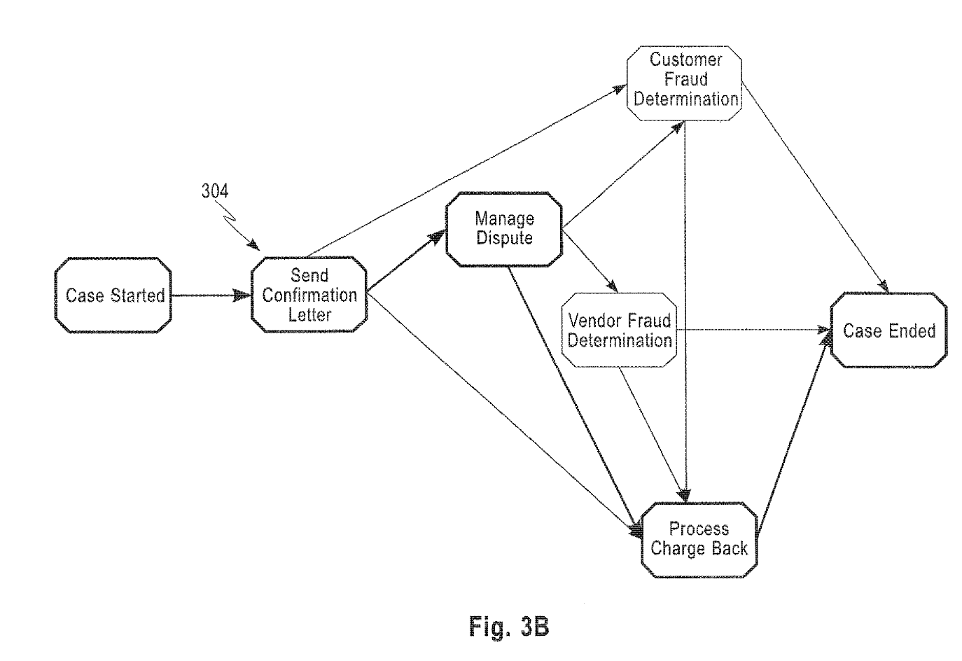

According to an embodiment of the present disclosure, one or more kinds of models may be mined from traces. These models include a probabilistic graph model (PGM) (see FIG. 1), process model (PM) (see FIG. 2), and a probabilistic process model (PPM) (see FIG. 3A). The PPM is a combination of a PM and a PGM. Existing algorithms may be used to mine models.

The PGM 100 is a directional graph with tasks as nodes (e.g., 101) connected by edges (e.g., 102). There is an edge from node “a” to node “b” if sequence “ab” is observed in the past event logs. At each node, transition probabilities are assigned to all outgoing edges (e.g., 0.35 in the case of edge 102). Transition probabilities at each node are summed up to one. In view of the foregoing, the probabilistic graph describes probabilities of going from one task to another task.

In the case of a PGM, one exemplary mining method includes an Ant-Colony Optimization (ACO) based probabilistic graph may be mined from case execution data. By applying ACO techniques a probabilistic graph may be constructed from traces that represent correlated case history data.

The PM component of the PPM captures the logical structure in the case such as loops, parallelism, joins and splits. For example, FIG. 2 shows a process 201 associated with a task 101, which includes a plurality of activities, A, B, C, D, E, F, G, and H. The activities may be connected by logic (e.g., XOR 203, SPLIT 204, JOIN 205, etc.). Again, a PPM is a combination of a PM and a PGM.

In the case of a process model, methods such as the known Alpha methods may be used for mining.

In the case of a PPM such as that shown in FIG. 3A, the directional graph includes tasks as nodes connected by edges. For example, the tasks “Send Confirmation Letter” (301) and “Manage Dispute” (302) are the most common tasks in all possible executions of the credit cart scenario case model, being connected by an edge 303 associated with a 99.3% prediction probability. Prediction probabilities may be updated with each incoming case trace. The probabilities in the PPM provide guidance on the likelihood and strength of transitions between process states that can be leveraged for predictions. The probabilities in the PPM can be updated in many different ways including using Ant Colony Optimization techniques that have been demonstrated to be useful for stochastic time-varying problems. Further, new PPMs may be mined to adapt to structural changes in the process.

According to an embodiment of the present disclosure, the display of minded models allows a user to interact with mined information. For example, a highest probability path may be displayed in the model (for example a PPM). Such a path is displayed in FIG. 3B. In FIG. 3B the path 304 is differentiated from non-path tasks by line weight. According to another example, the path may be differentiated from non-path tasks by color, opacity, e.g., with non-path tasks being shown in a comparatively light grey-tone, etc. In should be understood that selected components in a mined graph may be differentiated by various means and the disclosure is not limited to the examples described. In yet another example, non-path tasks may be eliminated from the display.

An example of a visualization may include a slider that, at one extreme, shows this path, and includes other tasks and paths as the slider is moved over to less probable events to display a spaghetti picture at another extreme that contains a multitude of tasks and paths.

According to an embodiment of the present disclosure, specific snapshots of the PGM may be shown with different fixed threshold probabilities visible. Coloring edges or otherwise highlighting them to convey probability and/or frequency is also useful.

According to an embodiment of the present disclosure, a heat map can show (e.g., by highlights, color, fill patterns, etc., the tasks and paths and highlighting which are most common (e.g., using a red fill) and which are less common (e.g., using a blue fill) so this is related. Another exemplary visualization may show time based bottlenecks in a directional graph of tasks.

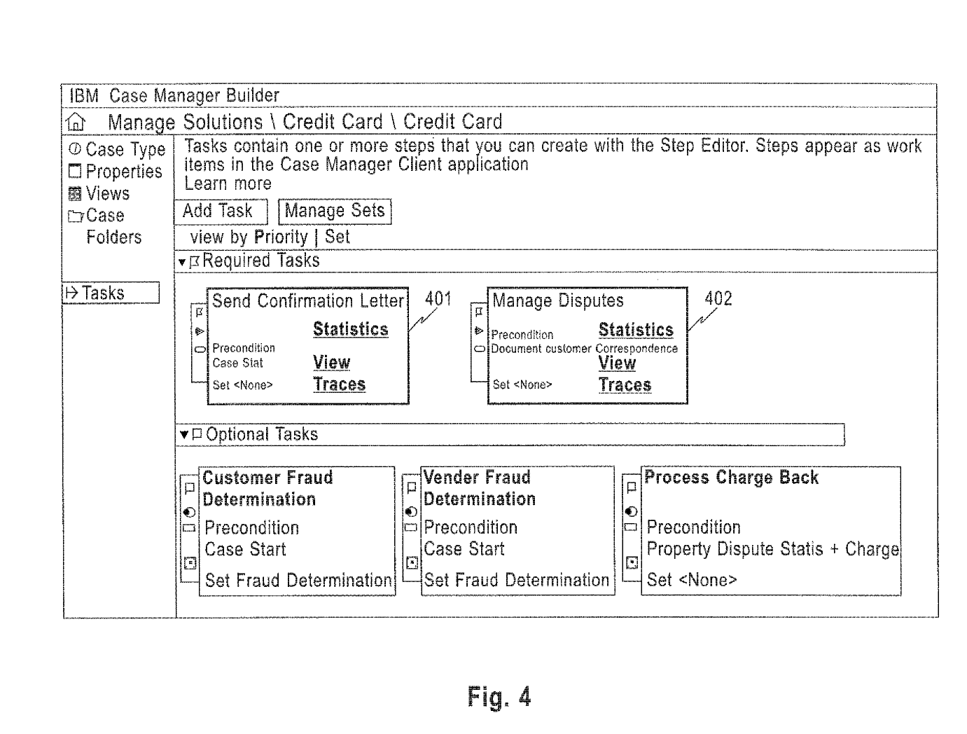

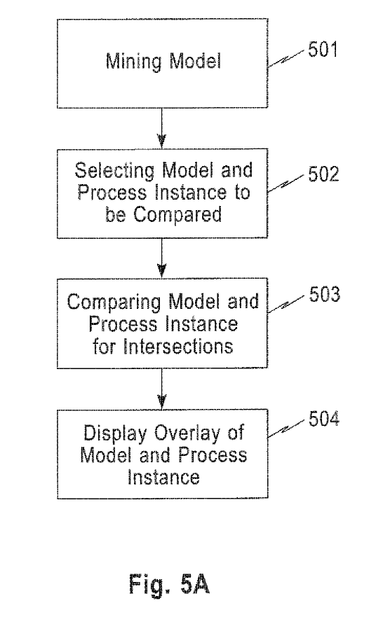

The mined model of the process may be mapped to a simplified model such as a diagram in the BPMN standard. The mined model may be mapped back to the case model and provide data on probabilities and frequencies on the case model. A user may click on statistics with respect to an activity to drill down, and view the traces, and intermediate process model characteristics that are related to that statistic. An example of such functionality is displayed in FIG. 4 and FIG. 5. The tasks “Send Confirmation Letter” (401) and “Manage Dispute” (402), corresponding to tasks 301 and 302 from FIG. 3A, are determined to be (1) the most common tasks in all possible executions of the credit cart scenario case model, and (2) as shown by the PGM these two tasks have the greatest out-degree. Their frequency and connectivity with other tasks can be determined via the PGM. As a result of the PGM analytics these tasks are highlighted in the case model view as shown in FIG. 5. They also have links to allow users to drill down on each task, view detailed statistics about them that are derived from mined models, and also drill down to view precise execution traces that exhibit the behavior captured by the mined models.

For a given task, possible next steps may be displayed based on known history. The next steps may be displayed as a table of probabilities. The probabilities are given by the outgoing edges of that task from the PGM. This may be done via a fly-over; as a case worker's mouse hovers over the current task, a flyover shows potential next steps that could be taken. Next steps for a given task T may be determined by querying a mined PGM of the case model, populating a list of all tasks connected to T by one edge, examining the probability of the edge e{T,X} connecting T to each such task X in the list, and removing all tasks in the list whose edge probability e {T,X} is less than a threshold.

A visualization may support an upstream drill. For a defined subgraph of the PGM, a query may be used to provide a list of business process execution traces from historical data, each of which exhibit the subgraph. A trace visualizer tool may be used to view these traces.

Referring to FIGS. 5A-5C, the trace visualizer tool may display different views of a processing including an overlay of a first trace set on a second trace set showing results of a mining algorithm (see FIG. 5B, highlighted path 501). An exemplary process for overlaying traces includes mining models 501, selecting at least one model to be compared to a process instance 502, comparing each task and edge in a current process instance against a list of tasks and edges in a process model 503. Any tasks and edges that intersect between the two sets or overlay may be highlighted on a visual diagram (e.g., at block 504), thus conveying the process instance overlay on a process model.

Referring to FIG. 5B, for example, the highlighted path 511 may be the result of the mining model, a comparison of behavior observed in a first trace set as compared to a second trace set. The first trace set may be a subset of the second trace set. This allows for the visualization of anomalies in the first trace set when compared to behavior of the mined model. Further examples include, a flow of a message through various composite and component instances, saved queries that return one or more traces, overlays of a trace with heuristics (see FIG. 5B with the edges to Task 4 (512, 513) highlighted that exist in the mined model but do not exist in the set of 6 traces). The interface of the tool may include features for selecting tasks, panning a trace, zooming in or out on the trace, etc.

According to an embodiment of the present disclosure, PGMs created from two subsets of historical data may be compared. The data may be the cases handled by a particular case worker. The comparison between mined models of different data sets may provide insight into how certain case workers handle certain outcomes.

According to an embodiment of the present disclosure, case handling behavior may be compared by converting a PGM into BPMN format and using known process model similarity methods to compare two process models in BPM format. The similarity methods will output a numeric value of the distance between the models.

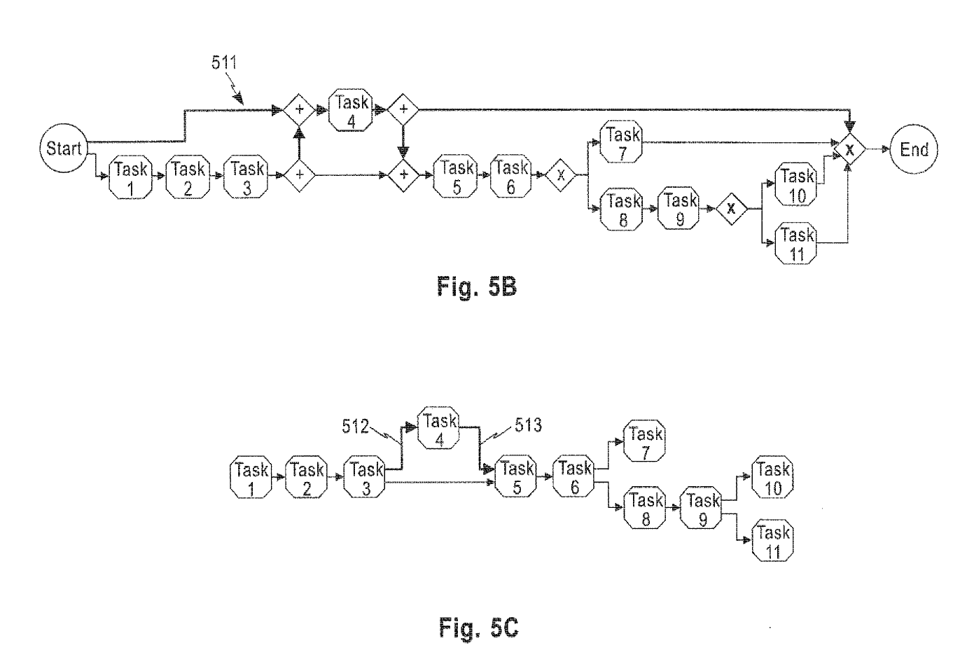

According to an embodiment of the present disclosure, model comparison (FIG. 6) is a part of a tool for interactively obtaining business process insight, wherea model comparison module extracts behavioral differences from models, highlights these behavioral differences on an extracted model, and stores comparison results. The tool further enables a user to add annotations on the models, and retrieve stored results and annotations at any point during runtime. The model comparison tool automatically determines the behavioral differences in models.

Referring to FIG. 6, the tool automatically detects the behavioral differences by mining models from different perspectives (block 601), for example, a model of a first case worker's case handling behavior, a model of all cases for processing drug X from Texas, a model of all cases handled in less than ten days, a model for all cases in which customers were 100% satisfied, etc. This is done by creating an input set of execution traces clustered by a perspective criteria. A list of perspectives can be automatically created by iterating and extracting information from an ontology of a business process or by extracting keywords after conducting text mining on a set of execution traces of a business process.

The tool may then iterate over each combination of these mined models (blocks 602 and 604), and compare two mined models, which fall in the same perspective category, but do not have the exact same perspective (block 603). For example, the tool may compare the model of the first case worker's case handling behavior to a second case worker's case handling behavior, or compare the model of all cases handled in less than ten days against a model of all cases handled in more than ten days, or compare the model of how cases from Texas are processed to a model of how cases from New York are processed. The tool may annotate the models with comparison information (block 605), storing the comparison information (block 607), and highlighting the comparison information when the user is examining a mined model from any one of the perspectives mentioned above (block 608). Further, annotations may be retrieved and displayed (block 606).

According to an embodiment of the present disclosure, a query builder of the tool enables the expression of custom queries specified by a user directly on the data. For example, a user may write queries such as “Find all transport events from Boston to New York City that occurred between April and June of 2011”. A system may response to a query by providing traces that contain the requested data in real time. The user may open each trace in a trace visualizer tool and view its contents. The queries and/or results may be saved automatically or by the user. The queries and/or results may be shared with other users using a collaborative system, along with any annotations. According to an embodiment of the present disclosure, the data exploration tool includes a query builder controlling an expression of at least one custom query directly on the data.

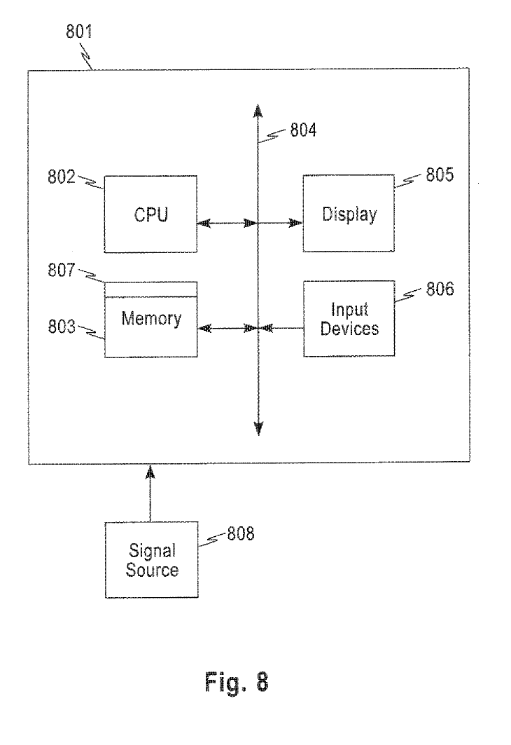

According to an embodiment of the present disclosure, a trace set may be stored to a collaborative system. The collaborative system may include one or more computer systems and/or software applications (for example, se FIG. 8) for accessing shared data, including for example, the trace set. According to an embodiment of the present disclosure, the shared data may include artifacts such as a query, a generated model, a model comparison result, and a trace sets generated in response to a query. A user annotation on each of these artifacts, along with the artifacts, may be stored in the collaborative system, and one or more users may retrieve stored results. For example, the collaborative system may be configured to provide a group of two or more users collaborating on a project access to a database storing artifacts. The collaborative system may receive an annotation from a first user of the group, wherein the annotation is associated with at least one of the artifacts. The annotation may be stored such that the at least one artifact is associated with the annotation, and is associated with a user who provided the annotation. The collaborative system may provide the group of users with access to the database including the artifacts and annotation.

Another exemplary method for comparing two different sets of execution traces includes using eigen analysis to determine a numeric measure of distance between two different sets of business process execution traces. Geetika T. Lakshmanan, Paul T. Keyser, Songyun Duan: Detecting changes in a semi-structured business process through spectral graph analysis. ICDE Workshops 2011: 255-260, describes a method for determining a difference between two sets of traces of a business process. The method includes aggregating successive disjoint sets of traces into successive instances of a complete graph, determining the graph spectra of each complete graph using standard techniques for graph spectra computation (such as eigenvector and eigenvalue analysis), and determining the difference between the graph spectra. The output is a numeric value indicating the difference between the two trace sets.

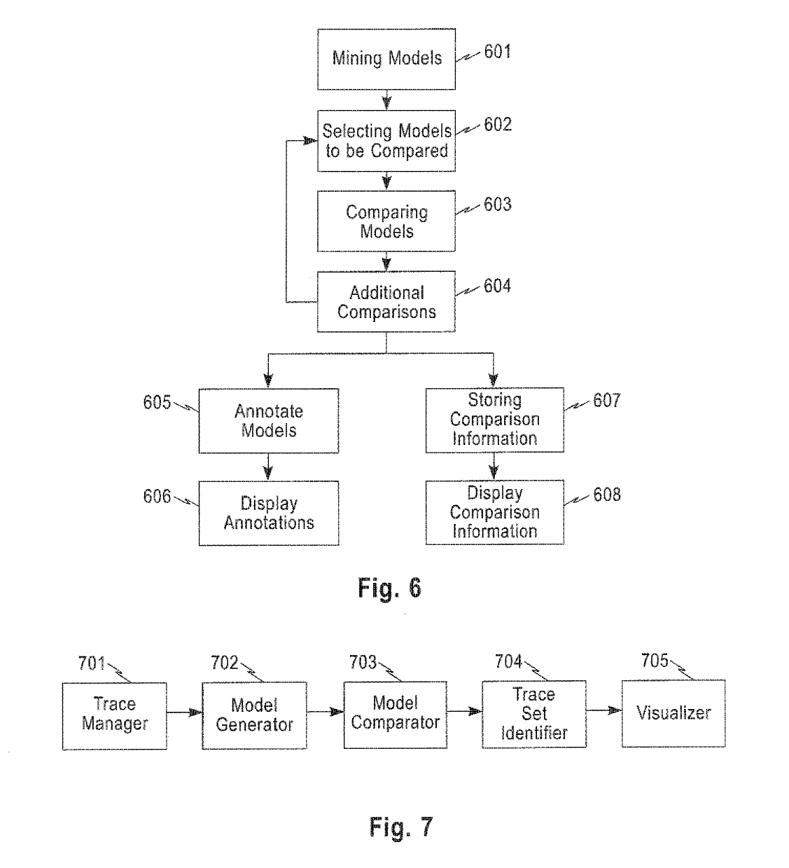

Referring to FIG. 7, a data exploration tool includes a trace manager (701) receiving a plurality of trace sets, each trace set having two or more business process execution traces, the business process execution traces being models of an individual work flow. The data exploration tool includes a model generator (702) is configured to create a model from each of the trace sets, the model being a directed graph showing the work flow of the aggregate of the business process execution traces in the respective trace set, the graph having one or more tasks nodes interconnected by one or more edges, the graph further having one or more paths from one or more begin functions to one or more end functions, each path having at least one task node between one of the start and end functions. The data exploration tool further includes a model comparator (703) configured to extract a plurality of behavioral differences between the models, storing a comparison results, and retrieve the comparison results during runtime, a trace set identifier (704) configured to identify a subset of trace set based on a selected subsection of the model, where a subset of trace set exhibit the behavior captured in the selected subsection of the model, and a visualizer (705) configured to display the subgraph.

According to an embodiment of the present disclosure, charts and graph plotting tools may be used in conjunction with a visualizer tool. For example, known charting APIs may be used to visualize the data provided by another method, such as a comparison of PGMs. According to an embodiment of the present disclosure, the visualizer is configured to display an overlay of a second trace set on a model generated by according to a first trace set.

The methodologies of embodiments of the disclosure may be particularly well-suited for use in an electronic device or alternative system. Accordingly, embodiments of the present disclosure may take the form of an entirely hardware embodiment or an embodiment combining software and hardware aspects that may all generally be referred to herein as a “processor”, “circuit,” “module” or “system.” Furthermore, embodiments of the present disclosure may take the form of a computer program product embodied in one or more computer readable medium(s) having computer readable program code stored thereon.

Any combination of one or more computer usable or computer readable medium(s) may be utilized. The computer-usable or computer-readable medium may be a computer readable storage medium. A computer readable storage medium may be, for example but not limited to, an electronic, magnetic, optical, electromagnetic, infrared, or semiconductor system, apparatus, device, or any suitable combination of the foregoing. More specific examples (a non-exhaustive list) of the computer-readable storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus or device.

Computer program code for carrying out operations of embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the present disclosure are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions.

These computer program instructions may be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

For example, FIG. 8 is a block diagram depicting an exemplary computer system for performing a method for automated data exploration. The computer system 801 may include a processor 802, memory 803 coupled to the processor (e.g., via a bus 804 or alternative connection means), as well as input/output (I/O) circuitry 805-806 operative to interface with the processor 802. The processor 802 may be configured to perform one or more methodologies described in the present disclosure, illustrative embodiments of which are shown in the above figures and described herein. Embodiments of the present disclosure can be implemented as a routine 807 that is stored in memory 803 and executed by the processor 802 to process the signal from the signal source 808. As such, the computer system 801 is a general-purpose computer system that becomes a specific purpose computer system when executing the routine 807 of the present disclosure.

It is to be appreciated that the term “processor” as used herein is intended to include any processing device, such as, for example, one that includes a central processing unit (CPU) and/or other processing circuitry (e.g., digital signal processor (DSP), microprocessor, etc.). Additionally, it is to be understood that the term “processor” may refer to a multi-core processor that contains multiple processing cores in a processor or more than one processing device, and that various elements associated with a processing device may be shared by other processing devices.

The term “memory” as used herein is intended to include memory and other computer-readable media associated with a processor or CPU, such as, for example, random access memory (RAM), read only memory (ROM), fixed storage media (e.g., a hard drive), removable storage media (e.g., a diskette), flash memory, etc. Furthermore, the term “I/O circuitry” as used herein is intended to include, for example, one or more input devices (e.g., keyboard, mouse, etc.) for entering data to the processor, and/or one or more output devices (e.g., printer, monitor, etc.) for presenting the results associated with the processor.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although illustrative embodiments of the present disclosure have been described herein with reference to the accompanying drawings, it is to be understood that the disclosure is not limited to those precise embodiments, and that various other changes and modifications may be made therein by one skilled in the art without departing from the scope of the appended claims.

What is claimed is:

1. A data exploration tool embodied in computer readable storage medium embodying instructions executed by a processor for visualizing a process, the data exploration tool comprising:
a trace manager receiving a plurality of trace sets, each trace set having a plurality of business process execution traces, each of the business process execution traces being a representation of an individual work flow;
a model generator creating a model from each of the trace sets, each model being a directed graph including a work flow of an aggregate of the business process execution traces in a respective trace set;
a model comparator extracting a plurality of differences between the models and creating a comparison result based on the plurality of differences, wherein the comparison result is stored to a collaborative system; and
a trace set identifier configured to identify a subset of the trace set based on a selected subsection of the model, where the subset of trace set exhibits at least one difference extracted from the selected subsection of the model.

2. The data exploration tool of claim 1, wherein the directed graph includes a plurality of tasks nodes interconnected by one or more edges, the directed graph further having one or more paths from one or more beginning functions to one or more end functions, and each path having at least one task node between one of the start and end functions.

3. The data exploration tool of claim 1, wherein the trace set identifier is configured to retrieve a subset of traces during a runtime in response to a query.

4. The data exploration tool of claim 1, further comprising a collaborative tool receiving an annotation of at least one of the models and storing the annotation to the collaborative system.

5. The data exploration tool of claim 4, wherein the model comparator is configured to retrieve the annotation during runtime.

6. The data exploration tool of claim 1, wherein the subset of traces is identified in response to a query, and the subset of traces and the query are stored to the collaborative system.

7. The data exploration tool of claim 6, wherein the model comparator is configured to retrieve the subset of traces during runtime in response to a stored query, and provide a comparison result.

8. The data exploration tool of claim 1, further comprising a visualizer configured to display the subset of the trace set.

9. The data exploration tool of claim 1, wherein the visualizer is configured to highlight an area of the subset of the trace set in the selected subsection of the model corresponding to anomalous behavior.

10. The data exploration tool of claim 1, further comprising a visualizer configured to display an overlay of a portion of another trace set of the plurality of trace sets on a portion of the model.

11. The data exploration tool of claim 10, wherein the visualizer compares each task and edge in the another trace set against each task and edge in the trace set, and identifies at least one task and/or edge that intersects between the another trace set and the trace set.

12. A computer readable storage medium embodying instructions executed by a processor for identifying differences between business process execution traces, the method comprising:
receiving a plurality of trace sets, each trace set having a plurality of business process execution traces, each of the business process execution traces being a representation of an individual work flow;
creating a model from each of the trace sets, each model being a directed graph including a work flow of an aggregate of the business process execution traces in a respective trace set;
extracting a plurality of differences between the models and creating a comparison result based on the plurality of differences; and
identifying a subset of the trace set based on a selected subsection of the model, where the subset of trace set exhibits at least one difference extracted from the selected subsection of the model.

13. The computer readable storage medium of claim 12, further comprising displaying the subset of the trace set.

14. The computer readable storage medium of claim 12, wherein the directed graph includes a plurality of tasks nodes interconnected by one or more edges, the directed graph further having one or more paths from one or more beginning functions to one or more end functions, and each path having at least one task node between the start and end functions.

15. The computer readable storage medium of claim 12, further comprising storing the comparison result.

16. The computer readable storage medium of claim 12, further comprising retrieving the comparison results during a runtime.

17. The computer readable storage medium of claim 12, further comprising storing the subset of the trace set.

18. The computer readable storage medium of claim 12, receiving at least one annotation of at least one of the models and storing the annotation to the collaborative system.

19. A computer readable storage medium embodying instructions executed by a processor for identifying differences between business process execution traces, the method comprising:
receiving a plurality of trace sets, each trace set having a plurality of business process execution traces, each of the business process execution traces being a representation of an individual work flow;
creating a model from each of the trace sets, each model being a directed graph including a work flow of an aggregate of the business process execution traces in a respective trace set;
extracting a plurality of differences between the models and creating a comparison result based on the plurality of differences;
identifying a subset of the trace set based on a selected subsection of the model, where the subset of trace set exhibits at least one difference extracted from the selected subsection of the model; and
displaying the subset of the trace set as an overlay on the selected subsection of the model, wherein the overlay is determined as based on intersections between the subset of the trace set and the selected subsection of the model.

20. The computer readable storage medium of claim 19, wherein the directed graph includes a plurality of tasks nodes interconnected by one or more edges, the directed graph further having one or more paths from one or more beginning functions to one or more end functions, and each path having at least one task node between the start and end functions.

21. The computer readable storage medium of claim 19, further comprising:
storing the subset of the trace set;
storing the comparison result;
receiving a query; and
retrieving at least one of the subset of the trace set and the comparison results during a runtime in response to the query.

22. The computer readable storage medium of claim 19, further comprising:
receiving at least one annotation of at least one of the models;
storing the annotation to the collaborative system;
receiving a query; and
retrieving the annotation during a runtime in response to the query.
